(19) United States
(12) Patent Application Publication
(10) Pub. No.: US 2008/0300971 A1
(43) Pub. Date: Dec. 4, 2008

(54) ADVERTISEMENT APPROVAL BASED ON TRAINING DATA

(75) Inventors: Hua-Jun Zeng, Beijing (CN); Hua Li, Beijing (CN); Jian Hu, Beijing (CN); Zheng Chen, Beijing (CN); Jian Wang, Beijing (CN)

Correspondence Address: PERKINS COIE LLP/MSFT, P. O. BOX 1247, SEATTLE, WA, 98111-1247, US

(73) Assignee: Microsoft Corporation, Redmond, WA (US)

(21) Appl. No.: 11/755,523

(22) Filed: May 30, 2007

(51) Int. Cl. G06Q 30/00

(52) U.S. Cl. 705/14

(57) ABSTRACT

A system for determining whether to approve a target document (e.g., advertisement) is provided. The system trains a classifier using tuples of words from appropriate documents and tuples of words from inappropriate documents. To approve a target document, the system identifies tuples of words of the target document. The system then applies the classifier to the identified tuples to classify the document as being appropriate or inappropriate. If the document is classified as appropriate, the system automatically approves the document.

### BACKGROUND

Many web sites and advertisement placement services generate considerable revenue from the placement of advertisements. The revenue model for many web sites is a clickthrough model in that an advertiser pays for placement of the advertisement only when a user clicks on the advertisement. The advertiser and the web site provider both have incentives to ensure that advertisements that are placed are likely to be of interest to the user of the web page. If the advertisement is not of interest, then the user is unlikely to click on the advertisement. For example, if the web page relates to the locations of basketball courts provided by a city and the advertisement relates to buying flowers, the user interested in the location of basketball courts is unlikely to be interested in buying flowers. If the user does not click on the advertisement, the web site provider loses revenue that might have been received if an advertisement of interest had been placed. If the user does click on the advertisement, the advertiser will pay for the advertisement even though the advertiser is unlikely to generate revenue from that placement because the user is unlikely to purchase flowers.

To help ensure that advertisements may be of interest to the user of a web page, advertisements are selected based on relevance to the content of the web page. To help ensure that advertisements are related to the content of a web page, the advertisers may specify a target word for placing an advertisement. If a web page is related to the target word, then the advertisement may be assumed to be related to the content of the web page. For example, an advertiser who is advertising basketball shoes may specify target words of “basketball shoe,” “basketball court,” and “basketball.” The advertiser may be willing to pay more for the advertisement when it is placed on a web page that contains the target word “basketball shoes” than the other two because it is more specific to the product being advertised.

Tens of thousands of advertisements may be submitted for placement on web pages everyday. To support this large volume of advertisements, the process of generating advertisements, identifying target words, submitting advertisements to advertisement placement services, and selecting advertisements for placement is highly automated. In many cases, there is no human involvement.

Although this automation may be highly efficient, sometimes an advertisement may contain words that are inappropriate for web pages. For example, it may be inappropriate to display an advertisement for breast enlargement on a web page devoted to discussing cancer issues. As another example, it may be inappropriate to display an advertisement for a sexually explicit video on a web page related to children's topics. To help prevent the placement of such inappropriate advertisements, advertisement placement services may use a watchlist or suspect list of words that may indicate an advertisement may be inappropriate. An advertisement placement service may scan an advertisement that has been submitted to see if it has any words on the watchlist. If it does not, then the advertisement is automatically approved for placement. If it does, then the advertisement may be designated potentially inappropriate and need to be manually approved for placement. Because of the large number of advertisements submitted every day for placement, the manual approval of the advertisements that contain words in the watchlist can be time-consuming and expensive. In addition, advertisers, web site providers, and advertisement placement services risk losing revenue as a result of a valuable and appropriate advertisement being designated potentially inappropriate while the advertisement waits for manual approval.

### SUMMARY

A document approval system for determining whether to approve a target document (e.g., advertisement) is provided. The system trains a classifier using tuples of words from appropriate documents and tuples of words from inappropriate documents. To approve a target document, the system identifies tuples of words of the target document. The system then applies the classifier to the identified tuples to classify the document as being appropriate or inappropriate. If the document is classified as appropriate, the system automatically approves the document.

A system for approving advertisements based on learning from training data that includes advertisements that are appropriate for placement and advertisements that are not appropriate for placement is provided. An advertisement approval system is used to automatically approve advertisements that have been designated as potentially inappropriate based on a subsequent automatic classification of the advertisement as appropriate. The advertisement approval system trains a classifier to classify advertisements as appropriate or not, using training data of appropriate advertisements and inappropriate advertisements. The training data may include advertisements that had previously been designated as potentially inappropriate and then manually designated as appropriate or inappropriate. The advertisement system learns from the training data the words that are likely to occur in appropriate advertisements and in inappropriate advertisements. After the classifier is trained, the advertisement approval system can then use the classifier for automatically approving advertisements that are initially designated as potentially inappropriate but then classified as appropriate by the classifier.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a block diagram that illustrates components of the advertisement approval system in one embodiment.

FIG. 2 is a block diagram that illustrates a data structure of the parameter store in one embodiment.

FIG. 3 is a block diagram that illustrates a data structure of the learn approval factor store in one embodiment.

FIG. 4 is a flow diagram that illustrates the processing of the learn classifier component of the advertisement approval system in one embodiment.

FIG. 5 is a flow diagram that illustrates the processing of the generate pairs component of the advertisement approval system in one embodiment.

FIG. 6 is a flow diagram that illustrates the processing of the initialize parameter tables component of the advertisement approval system in one embodiment.

FIG. 7 is a flow diagram that illustrates the processing of the calculate probabilities component of the advertisement approval system in one embodiment.

FIG. 8 is a flow diagram that illustrates the processing of the calculate pair scores component of the advertisement approval system in one embodiment.

FIG. 9 is a flow diagram that illustrates the processing of the generate advertisement/pairs table component of the advertisement approval system in one embodiment.

FIG. 10 is a flow diagram that illustrates the processing of the learn approval factor component of the advertisement approval system in one embodiment.

FIG. 11 is a flow diagram that illustrates the processing of the calculate advertisement score component of the advertisement approval system in one embodiment.

FIG. 12 is a flow diagram that illustrates the processing of the advertisement classifier component of the advertisement approval system in one embodiment.

### DETAILED DESCRIPTION

A system for approving advertisements based on learning from training data that includes advertisements that are appropriate for placement and advertisements that are not appropriate for placement is provided. In some embodiments, an advertisement approval system is used to automatically approve advertisements that have been designated as potentially inappropriate based on a subsequent automatic classification of the advertisement as appropriate. The advertisement approval system may determine that an advertisement, including content and a target word, is potentially inappropriate because it contains an image, a word or combination of words, or some other information that often appears in inappropriate advertisements. The advertisement approval system trains a classifier to classify advertisements as appropriate or not, using training data of appropriate advertisements and inappropriate advertisements. The training data may include advertisements that had previously been designated as potentially inappropriate and then manually designated as appropriate or inappropriate. The advertisement system learns from the training data the words that are likely to occur in appropriate advertisements and in inappropriate advertisements. The advertisement system may use various machine learning techniques, such as naïve Bayes, support vector machines, and so on, to train a classifier to classify the advertisements as appropriate or inappropriate. After the classifier is trained, the advertisement approval system can then use the classifier for automatically approving advertisements that are initially designated as potentially inappropriate but then classified as appropriate by the classifier. In this way, many appropriate advertisements that are initially designated as potentially inappropriate can be quickly classified as appropriate without manual review and be available for placement without the delay associated with manual review.

In some embodiments, the advertisement approval system classifies advertisements as appropriate or inappropriate based on a likelihood that combinations of words of an advertisement that are in a watchlist and other words of the advertisement are appropriate or inappropriate advertisements. The advertisement approval system trains the classifier by generating an appropriate pair score and an inappropriate pair score for pairs of words of the advertisements. Each pair of words includes a watchlist word and another word from an advertisement. For example, if an advertisement includes the words “breast cancer surgery” and the word “breast” is a watchlist word, then the pairs would include “breast cancer” and “breast surgery.” Such an advertisement of the training data may be designated as appropriate. As another example, if an advertisement includes the words “breast enlargement surgery,” then the pairs would include “breast enlargement” and “breast surgery.” Such an advertisement of the training data may be designated as inappropriate. The advertisement approval system may also use triples of words, quadruples of words, or tuples of any other length with one word being from the watchlist. The triples or quadruples may be used in place of the pairs or in addition to the pairs.

The advertisement approval system divides the training data into advertisements that are appropriate and inappropriate and performs similar training for each division. Thus, the advertisement approval system will effectively have a sub-classifier trained to indicate whether an advertisement is appropriate and a sub-classifier trained to indicate whether an advertisement is inappropriate. The advertisement approval system then classifies advertisements based on a comparison of the scores generated by the sub-classifiers. To train a sub-classifier, the advertisement approval system identifies pairs of words from each advertisement and counts the number of times each word appears in a pair of the division and the number of times each pair occurs in the division. For example, the word “breast” may occur in 100 pairs, the word “cancer” may occur in 50 pairs, and the pair may occur in “breast cancer” 10 times in the appropriate advertisements. The advertisement approval system then generates a probability for each word and unique pair for a sub-classifier that is the count of that word or pair divided by the number of words or pairs in the division. For example, if the division of appropriate advertisements includes a total of 10,000 words and 10,000 pairs, then the probability for the word “breast” will be 0.01, for the word “cancer” will be 0.005, and for the pair “breast cancer” will be 0.001. The advertisement approval system then generates a pair score for each pair that indicates its likelihood to be in an advertisement of the division. The advertisement approval system may generate an appropriate pair score based on mutual information according to the following:

APS(w₁,w₂)=p(w₁,w₂)*(p(w₁,w₂))/(p(w₁)*p(w₁))

where APS represents the appropriate pair score for words w₁ and w₂, p(w₁) represents the probability of word w₁, p(w₂) represents the probability of word w₂, and p(w₁,w₂) represents the probability of the pair of words w₁ and w₂. For example, the appropriate pair score (APS) for “breast cancer” would be approximately 0.0011, and the inappropriate pair score (IPS) for “breast cancer” would likely be lower. The appropriate pair scores and the inappropriate pair scores represent the learned sub-classifier parameters for the appropriate and inappropriate sub-classifiers. In some embodiments, the advertisement approval system may use a support vector machine to train a classifier using the pairs and their designations as appropriate or inappropriate.

To classify an advertisement, the advertisement approval system generates an appropriate advertisement score using the appropriate sub-classifier and an inappropriate advertisement score using the inappropriate sub-classifier for the advertisement. An appropriate advertisement score indicates a likelihood that the advertisement is appropriate, and an inappropriate advertisement score indicates the likelihood that the advertisement is inappropriate. If the appropriate advertisement score and the inappropriate advertisement score indicate that the advertisement is much more likely to be appropriate, the advertisement approval system may automatically approve the advertisement. Otherwise, the advertisement approval system may indicate that it cannot automatically approve the advertisement and that the advertisement may need to be reviewed by a person. To generate the advertisement scores, the advertisement approval system generates pairs of words from the advertisement with each word of the advertisement from the watchlist and another word of the advertisement. The advertisement approval system then calculates the appropriate advertisement score by combining the appropriate pair scores and calculates the inappropriate advertisement score by combining the inappropriate pair scores. The advertisement approval system may combine the appropriate pair scores as follows:

AAS=ΣAPS(w₁,w₂)

where AAS represents an appropriate advertisement score, (w₁,w₂) represents a pair of the advertisement, and APS represents the appropriate pair score for the pair (w₁,w₂). The advertisement approval system calculates an inappropriate advertisement score (IAS) in a similar manner. The advertisement approval system then compares the appropriate advertisement score to the inappropriate advertisement score to determine whether the advertisement is likely appropriate and should be automatically approved. The advertisement approval system may approve the advertisement when an approval criterion is satisfied such as follows:

α*AAS>IAS

where α represents an approval factor indicating generally how much larger the appropriate advertisement score needs to be than the inappropriate advertisement score to automatically approve the advertisement. Other approval criteria may be used to determine whether to automatically approve an advertisement such as the ratio of the appropriate and inappropriate advertisement scores, the ratio of the squares of the appropriate and inappropriate advertisement scores, and so on.

In some embodiments, the advertisement approval system learns the approval factor using some of the training data. The advertisement approval system may reserve some of the training data for learning the approval factor. For example, the advertisement approval system may use 80% of the advertisements of the training data for learning the parameters of the sub-classifiers and the remaining 20% for learning the approval factor. To learn the approval factor, the advertisement approval system classifies each advertisement of the reserved training data using various possible values of the approval factor. For each value of the approval factor, the advertisement approval system counts the number of the inappropriate advertisements that were incorrectly approved by the classifier. The advertisement approval system then selects the approval factor with the lowest number as the approval factor for the classifier.

The computing device on which the advertisement approval system is implemented may include a central processing unit, memory, input devices (e.g., keyboard and pointing devices), output devices (e.g., display devices), and storage devices (e.g., disk drives). The memory and storage devices are computer-readable media that may be encoded with computer-executable instructions that implement the advertisement approval system, which means a computer-readable medium that contains the instructions. In addition, the instructions, data structures, and message structures may be stored or transmitted via a data transmission medium, such as a signal on a communication link. Various communication links may be used, such as the Internet, a local area network, a wide area network, a point-to-point dial-up connection, a cell phone network, and so on.

Embodiments of the system may be implemented in and used with various operating environments that include personal computers, server computers, hand-held or laptop devices, multiprocessor systems, microprocessor-based systems, programmable consumer electronics, digital cameras, network PCs, minicomputers, mainframe computers, computing environments that include any of the above systems or devices, and so on.

The advertisement approval system may be described in the general context of computer-executable instructions, such as program modules, executed by one or more computers or other devices. Generally, program modules include routines, programs, objects, components, data structures, and so on that perform particular tasks or implement particular abstract data types. Typically, the functionality of the program modules may be combined or distributed as desired in various embodiments. For example, separate computing systems may learn the parameters, learn the approval factor, and classify advertisements.

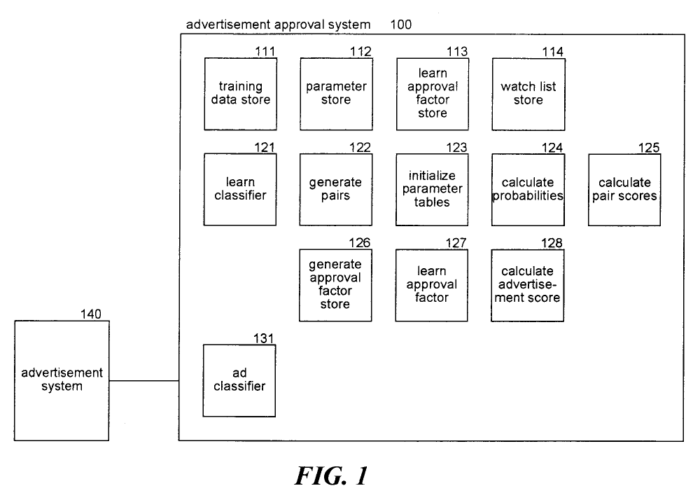

FIG. 1 is a block diagram that illustrates components of the advertisement approval system in one embodiment. The advertisement approval system 100 includes a training data store 111, a parameter store 112, a learn approval factor store 113, and a watchlist store 114. The training data store contains the advertisements for use in training the classifier along with an indication of whether each advertisement is appropriate or inappropriate. The parameter store contains the calculated appropriate and inappropriate pair scores for each sub-classifier and the approval factor. The parameter store may also contain data used in generating the pair scores such as counts and probabilities. The learn approval factor store contains a data structure used in learning the approval factor. The watchlist store contains a list of words such that if an advertisement contains at least one of the words on the list, the advertisement is potentially inappropriate.

The advertisement approval system also includes a learn classifier component 121, a generate pairs component 122, an initialize parameter tables component 123, a calculate probabilities component 124, a calculate pair scores component 125, a generate approval factor store component 126, a learn approval factor component 127, and a calculate advertisement score component 128. The learn classifier component invokes the various components to calculate the appropriate pair scores and the inappropriate pair scores for the sub-classifiers and to learn the approval factor. The generate pairs component generates pairs of words from an advertisement with one of the words being from the watchlist. The initialize parameter tables component initializes the tables of the parameter store. The calculate probabilities component calculates probabilities for words and pairs. The calculate pair scores component calculates the pair scores for the pairs. The generate approval factor store component generates tables of the learn approval factor store for use in learning the approval factor. The learn approval factor component learns the approval factor from the data of the learn approval factor store. The calculate advertisement score component calculates an advertisement score for an advertisement and functions as a sub-classifier.

The advertisement approval system may also include an advertisement classifier component 131. The component receives an advertisement designated as potentially inappropriate, generates pairs for the advertisement, calculates an appropriate advertisement score and an inappropriate advertisement score, and approves the advertisement when the appropriate advertisement score and the inappropriate advertisement score satisfy an approval criterion. The advertisement approval system may interface with an advertisement system 140 that provides the training data and advertisements that are potentially inappropriate for approval.

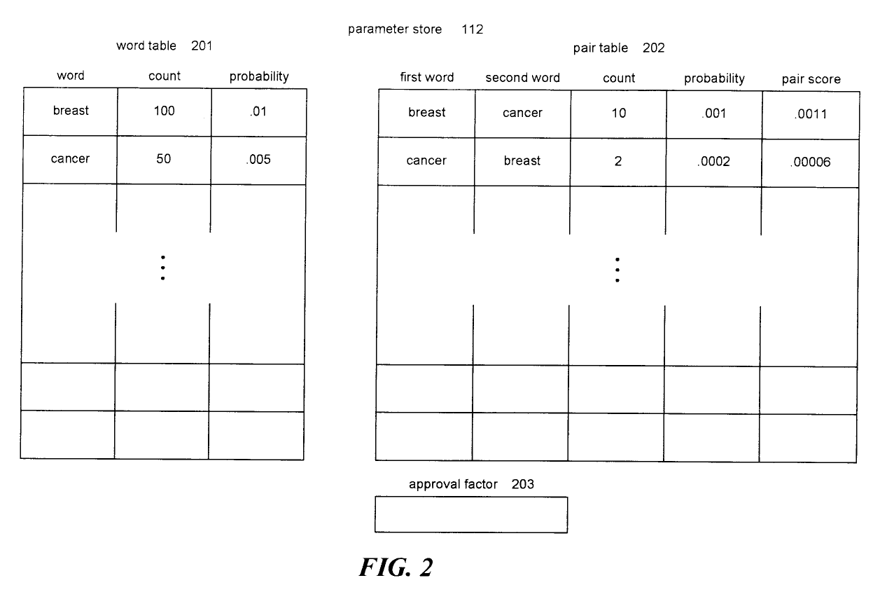

FIG. 2 is a block diagram that illustrates a data structure of the parameter store in one embodiment. The parameter store 112 includes a data structure for the appropriate sub-classifier and another for the inappropriate sub-classifier. The data structure of both sub-classifiers includes a word table 201 and a pairs table 202. The parameter store also includes an approval factor 203. The word table for the appropriate sub-classifier includes an entry for each word (excluding noise words) found in an appropriate advertisement used to train the classifier. Each entry includes the word, a count of the number of times the word occurs in the appropriate advertisements, and a probability that a word in an appropriate advertisement is that word. The pairs table for the appropriate sub-classifier includes an entry for each pair of words found in an appropriate advertisement used to train the classifier. Each entry includes the pair of words, a count of the number of times the pair appears in an appropriate advertisement, a probability that an appropriate advertisement contains that pair, and a pair score. The parameter store includes corresponding tables for the inappropriate sub-classifier. The approval factor is a field that contains the approval factor learned from the advertisements.

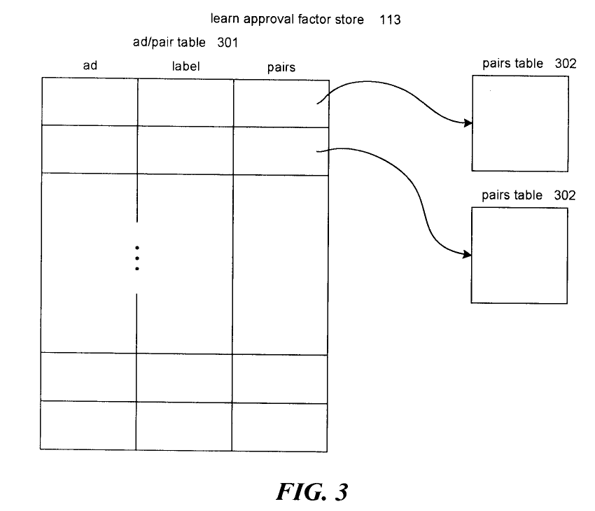

FIG. 3 is a block diagram that illustrates a data structure of the learn approval factor store in one embodiment. The learn approval factor store 113 includes an advertisement/pairs table 301 and pairs tables 302. The advertisement/pairs table contains an entry for each advertisement used in learning the approval factor. Each entry contains the advertisement, the designation of the advertisement as appropriate or inappropriate, and a reference to a pairs table. Each pairs table contains the pairs of words for the corresponding advertisement.

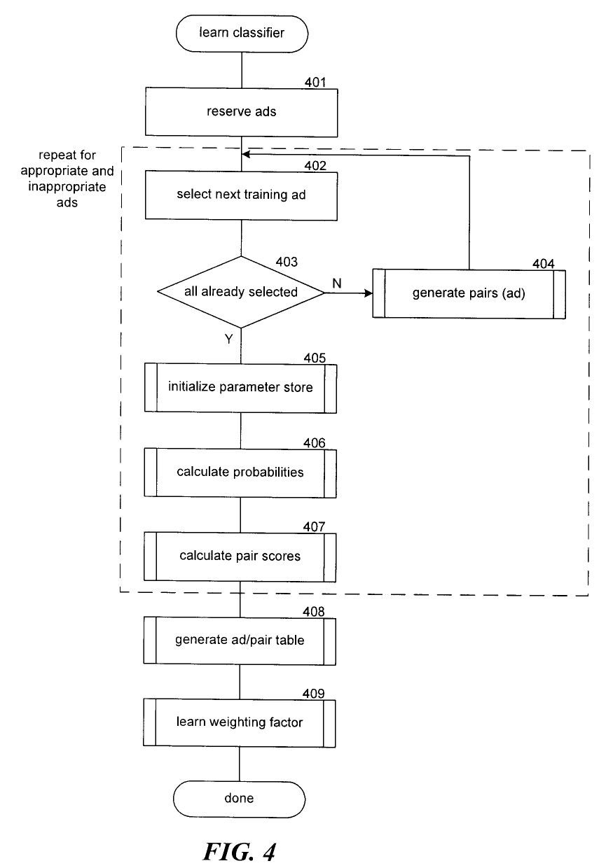

FIG. 4 is a flow diagram that illustrates the processing of the learn classifier component of the advertisement approval system in one embodiment. The component calculates the pair scores for pairs found in the appropriate advertisements and the pair scores for the inappropriate advertisements and learns the approval factor. In block 401, the component reserves a portion of the training advertisements for use in learning the approval factor. In blocks 402-407, the component calculates the pairs of scores for a sub-classifier. The component performs the functions of these blocks twice, once for the appropriate sub-classifier and once for the inappropriate sub-classifier of the training data, to generate the data structures of the parameter stores. In block 402, the component selects the next training advertisement for the sub-classifier being trained. In decision block 403, if all the training advertisements have already been selected, then the component continues at block 405, else the component continues at block 404. In block 404, the component invokes the generate pairs component to generate the pairs for the selected advertisement and then loops to block 402 to select the next advertisement for training. In block 405, the component invokes an initialize parameter tables component to initialize the parameter store for the sub-classifier being trained. In block 406, the component invokes the calculate probabilities component to calculate the probabilities of the words and pairs of words for the sub-classifier being trained. In block 407, the component invokes the calculate pair scores component to calculate the pair scores for the pairs for the sub-classifier being trained. In block 408, the component invokes a generate advertisement/pairs table component to generate a data structure to facilitate in learning the approval factor. In block 409, the component invokes the learn approval factor component and then completes.

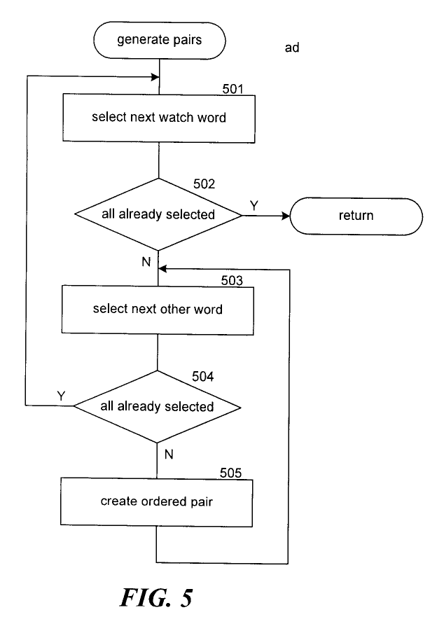

FIGS. 5-9 are flow diagrams that illustrate the generating of the pair scores. These figures are described in reference to generating the pair scores for the appropriate sub-classifier with the understanding that similar processing is performed for the inappropriate sub-classifier. The same components may be used with a parameter indicating which sub-classifier is being trained. FIG. 5 is a flow diagram that illustrates the processing of the generate pairs component of the advertisement approval system in one embodiment. The component is passed an appropriate advertisement used for training and generates pairs of words that include a watchword and another word of the advertisement. In block 501, the component selects the next watchword. In decision block 502, if all the watchwords have already been selected, then the component returns, else the component continues at block 503. In block 503, the component selects the next other word of the appropriate advertisement. In decision block 504, if all the other words for the selected watchword have already been selected, then the component loops to block 501 to select the next watchword, else the component continues at block 505. In block 505, the component creates an ordered pair of the selected watchword and the selected other word in an order based on the position of the words within the appropriate advertisement. That is, if the watchword occurs before the other word in the advertisement, then the watchword is first in the ordered pair. Otherwise, it is second. The component then loops to block 503 to select the next other word.

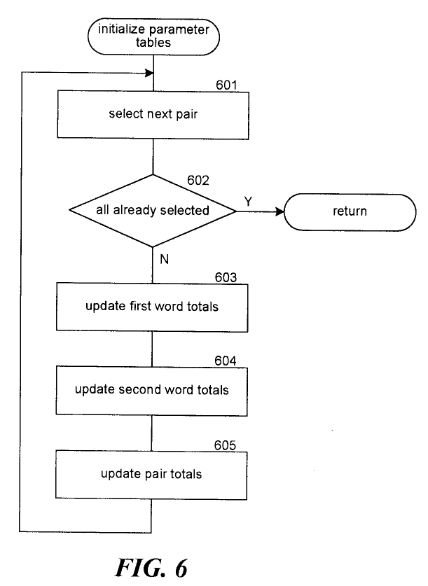

FIG. 6 is a flow diagram that illustrates the processing of the initialize parameter tables component of the advertisement approval system in one embodiment. The component is passed the generated pairs of words for the appropriate advertisements. The component adds entries to the word table for each word and an entry to the pairs table for each pair. In block 601, the component selects the next pair. In decision block 602, if all the pairs have already been selected, then the component returns, else the component continues at block 603. In block 603, the component adds an entry to the word table for the appropriate sub-classifier for the first word of the pair if not already in the table and increments the count of the entry for the word. In block 604, the component adds an entry to the word table for the appropriate sub-classifier for the second word of the pair if not already in the table and increments the count of the entry for the word. In block 605, the component adds an entry to the pairs table for the appropriate sub-classifier for the pair if not already in the table and increments the count of the entry for the pair and then loops to block 601 to select the next pair.

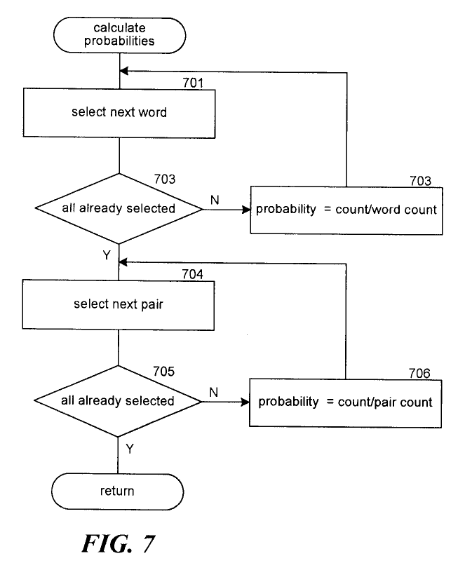

FIG. 7 is a flow diagram that illustrates the processing of the calculate probabilities component of the advertisement approval system in one embodiment. The component calculates the probabilities for the words and pairs for the appropriate sub-classifier based on the counts of the word table and pairs table for the appropriate sub-classifier. In blocks 701-703, the component loops calculating the probability for each word of the word table of the appropriate sub-classifier. In block 701, the component selects the next word of the word table. In decision block 702, if all the words have already been selected, then the component continues at block 704, else the component continues at block 703. In block 703, the component sets the probability for that word to the count of the word divided by the number of occurrences of words within the appropriate advertisements used for training. In blocks 704-706, the component loops calculating the probability for each pair of the pairs table for the appropriate sub-classifier. In block 704, the component selects the next pair of the pairs table. In decision block 705, if all the pairs have already been selected, then the component returns, else the component continues at block 706. In block 706, the component calculates the probability for the selected pair as the count of the pair divided by the number of occurrences of pairs within the appropriate advertisements used for training and then loops to block 704 to select the next pair.

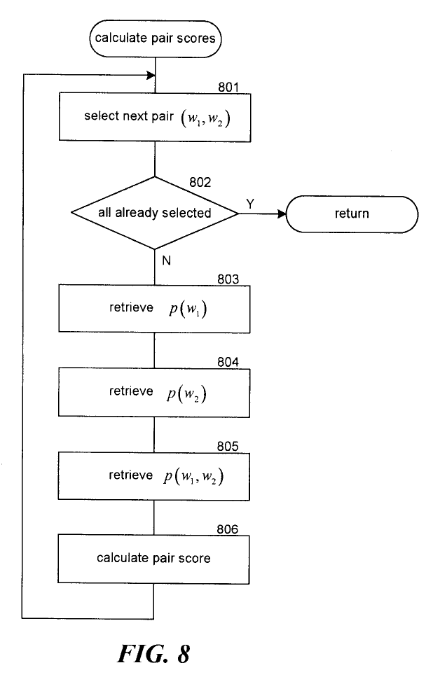

FIG. 8 is a flow diagram that illustrates the processing of the calculate pair scores component of the advertisement approval system in one embodiment. The component calculates pair scores for the pairs of the appropriate advertisements. In block 801, the component selects the next pair from the pairs table for the appropriate advertisements. In decision block 802, if all the pairs have already been selected, then the component returns, else the component continues at block 803. In block 803, the component retrieves the probability for the first word of the pair from the word table for the appropriate sub-classifier. In block 804, the component retrieves the probability for the second word of the pair from the word table of the appropriate sub-classifier. In block 805, the component retrieves the probability of the pair from the pairs table of the appropriate sub-classifier. In block 806, the component calculates the pair score and then loops to block 801 to select the next pair

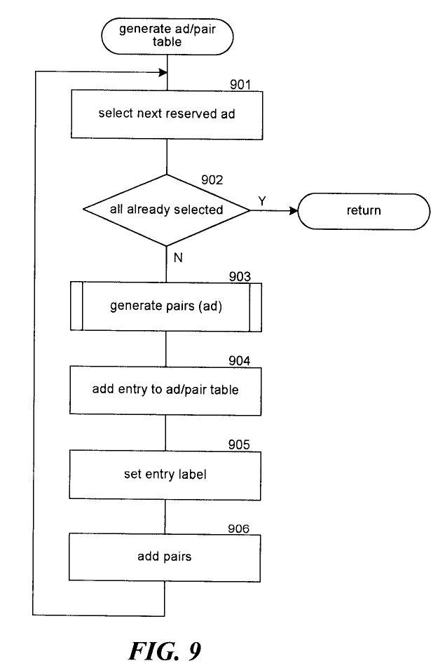

FIG. 9 is a flow diagram that illustrates the processing of a generate advertisement/pairs table component of the advertisement approval system in one embodiment. The component generates the advertisement/pairs table to facilitate the learning of the approval factor. In block 901, the component selects the next training advertisement that has been reserved for learning the approval factor. In decision block 902, if all the advertisements have already been selected, then the component returns, else the component continues at block 903. In block 903, the component invokes the generate pairs component passing the selected advertisement. In block 904, the component adds an entry to the advertisement/pairs table for the selected advertisement. In block 905, the component stores the designation of the advertisement as being appropriate or inappropriate. In block 906, the component adds the advertisement pairs to the pairs table for the selected advertisement. The component then loops to block 901 to select the next advertisement.

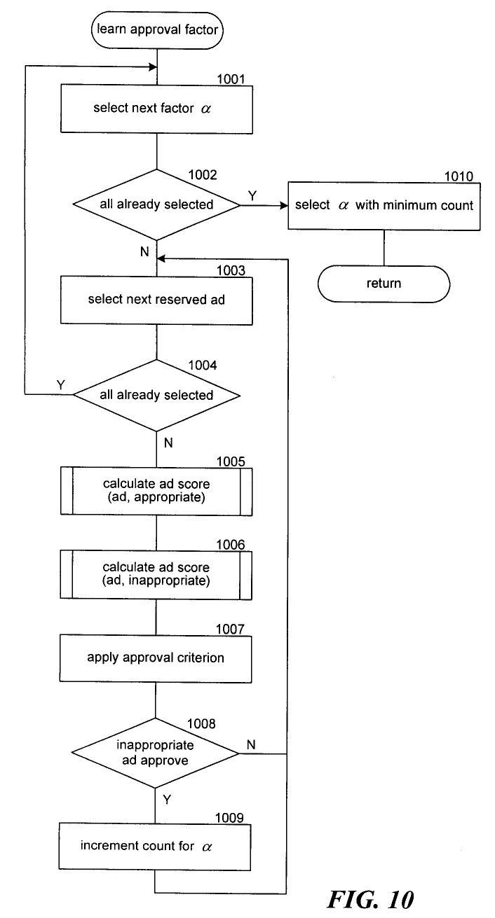

FIG. 10 is a flow diagram that illustrates the processing of the learn approval factor component of the advertisement approval system in one embodiment. The component uses the data of the advertisement/pairs table to learn the approval factor. The component tests various approval factors and selects the approval factor with the best performance. In block 1001, the component selects a next approval factor. For example, the component may start with a minimum approval factor and increase the approval factor for each by a small amount for each test and continue until a maximum approval factor is encountered. In decision block 1002, if all the approval factors in the minimum to maximum range have already been selected, then the component continues at block 1010, else the component continues at block 1003. In blocks 1003-1009, the component loops classifying each reserved advertisement as appropriate or inappropriate using the selected approval factor. In block 1003, the component selects the next reserved advertisement. In decision block 1004, if all the advertisements have already been selected, then the component loops to block 1001 to select the next approval factor, else the component continues at block 1005. In block 1005, the component invokes the calculate advertisement score component to calculate an appropriate advertisement score for the selected advertisement. In block 1006, the component invokes the calculate advertisement score component to calculate an inappropriate advertisement score for the selected advertisement. In block 1007, the component applies the approval criterion to the appropriate advertisement score and the inappropriate advertisement score. In decision block 1008, if an inappropriate advertisement has been approved, then the component continues at block 1009, else the component loops to block 1003 to select the next reserved advertisement. In block 1009, the component increments the count of inappropriate advertisements that have been approved for the selected approval factor and loops to block 1003 to select the next reserved advertisement. In block 1010, the component selects the approval factor with the minimum count as the approval factor for the classifier and then returns. One skilled in the art will appreciate that if only the count of inappropriate advertisements that have been approved is used to select the approval factor, then only inappropriate advertisements need to be classified to learn the approval factor. However, other techniques may be used to select the approval factor. For example, the selection may factor in how many appropriate advertisements were incorrectly not approved.

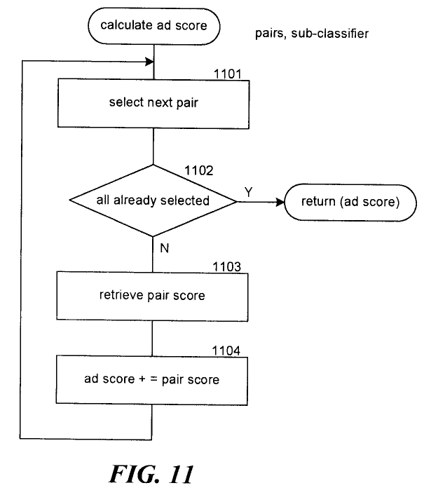

FIG. 11 is a flow diagram that illustrates the processing of the calculate advertisement score component of the advertisement approval system in one embodiment. The component is passed pairs of an advertisement and a designation of a sub-classifier (i.e., appropriate or inappropriate) and calculates the advertisement score for that sub-classifier. In block 1101, the component selects the next pair from the pairs table corresponding to the sub-classifier. In decision block 1102, if all the pairs have already been selected, then the component returns the advertisement score, else the component continues at block 1103. In block 1103, the component retrieves the pair score for the selected pair. In block 1104, the component aggregates the pair score into an advertisement score for the sub-classifier and then loops to block 1101 to select the next pair.

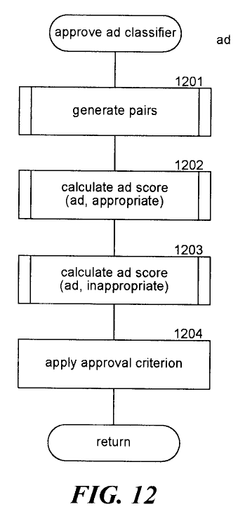

FIG. 12 is a flow diagram that illustrates the processing of the advertisement classifier component of the advertisement approval system in one embodiment. The component is passed a target advertisement and returns an indication of whether the target advertisement is approved or not. In block 1201, the component invokes the generate pairs component to generate the pairs for the target advertisement. In block 1202, the component invokes the calculate advertisement score component to generate the appropriate advertisement score for the target advertisement. In block 1203, the component invokes the calculate advertisement score component to calculate the inappropriate advertisement score for the target advertisement. In block 1204, the component applies the approval criterion to the appropriate advertisement score and inappropriate advertisement score to determine whether to approve the target advertisement. The component then returns an indication of whether the target advertisement was approved.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. One skilled in the art will appreciate that the document approval system can be used to approve documents other than advertisements. For example, the document approval system may be used to approve documents such as blog entries, content of linked-to web pages, customer reviews, electronic mail messages, and so on. Accordingly, the invention is not limited except as by the appended claims.

I/We claim:

1. A method in a computing device for approving an advertisement, the method comprising:
identifying pairs of words of the advertisement, each pair including a word of the advertisement that is in a watchlist and another word of the advertisement;
generating an appropriate advertisement score indicating whether the advertisement is appropriate, the appropriate advertisement score generated from appropriate pair scores of the identified pairs, an appropriate pair score for an identified pair indicating whether the identified pair is likely in an appropriate advertisement;
generating an inappropriate advertisement score indicating whether the advertisement is inappropriate, the inappropriate advertisement score generated from inappropriate pair scores of the identified pairs, an inappropriate pair score for an identified pair indicating whether the identified pair is likely in an inappropriate advertisement; and
indicating whether to approve the advertisement based on comparison of the appropriate advertisement score to the inappropriate advertisement score.

2. The method of claim 1 wherein an appropriate pair score for a pair is derived from a probability that the pair is from an appropriate advertisement and an inappropriate pair score for a pair is derived from a probability that the pair is from an inappropriate advertisement.

3. The method of claim 1 wherein the appropriate pair score for a pair is a mutual information score derived from probabilities of the words of the pair and the probability that the pair is from an appropriate advertisement and the inappropriate pair score for a pair is a mutual information score derived from probabilities of the words of the pair and the probability that the pair is from an inappropriate advertisement.

4. The method of claim 3 wherein the appropriate advertisement score is a sum of the appropriate pair scores and the inappropriate advertisement score is a sum of the inappropriate pair scores.

5. The method of claim 4 wherein the appropriate pair scores are derived from training data of appropriate advertisements and the inappropriate pair scores are derived from training data of inappropriate advertisements.

6. The method of claim 1 wherein the appropriate pair scores are derived from training data of appropriate advertisements and the inappropriate pair scores are derived from training data of inappropriate advertisements.

7. The method of claim 6 wherein the appropriate pair scores are generated for all pairs within training data of appropriate advertisements and the inappropriate pair scores are generated for all pairs within training data of inappropriate advertisements.

8. The method of claim 1 wherein the indicating includes indicating to approve when the appropriate advertisement score and the inappropriate advertisement score satisfy an approval criterion.

9. The method of claim 8 wherein an approval factor for the approval criterion is learned by assessing the effectiveness of different approval factors on inappropriate advertisements.

10. A computer-readable medium encoded with instructions for controlling a computing device to approve a target advertisement, comprising:
providing training data including advertisements that contain a word in a watchlist, each advertisement being designated as appropriate or inappropriate;
identifying pairs of words of the advertisements, each pair including a word of an advertisement that is in a watchlist and another word of the advertisement;
for unique pairs of words identified from an appropriate advertisement, generating an appropriate pair score for the pair indicating whether the pair is likely to be in an appropriate advertisement;
for unique pairs of words identified from an inappropriate advertisement, generating an inappropriate pair score for the pair indicating whether the pair is likely in an inappropriate advertisement;
identifying pairs of words of the target advertisement, each pair including a word of the target advertisement that is in a watchlist and another word of the target advertisement; and
determining whether to approve the target advertisement based on comparison of an appropriate advertisement score derived from the appropriate pair scores of the identified pairs and an inappropriate advertisement score derived from the inappropriate pair scores of the identified pairs.

11. The computer-readable medium of claim 10 wherein the appropriate pair score for a pair is derived from a probability that the pair is from an appropriate advertisement and the inappropriate pair score for a pair is derived from a probability that the pair is from an inappropriate advertisement.

12. The computer-readable medium of claim 10 wherein the appropriate pair score for a pair is a mutual information score derived from probabilities of the words of the pair and the probability that the pair is from an appropriate advertisement and the inappropriate pair score for a pair is a mutual information score derived from probabilities of the words of the pair and the probability that the pair is from an inappropriate advertisement.

13. The computer-readable medium of claim 12 wherein the appropriate advertisement score is a sum of the appropriate pair scores and the inappropriate advertisement score is a sum of the inappropriate pair scores.

14. The computer-readable medium of claim 10 wherein the indicating includes indicating to approve when the appropriate advertisement score and the inappropriate advertisement score satisfy an approval criterion.

15. The computer-readable medium of claim 14 wherein an approval factor for the approval criterion is learned by assessing the effectiveness of different approval factors on inappropriate advertisements.

16. A computing device for determining whether to approve a target advertisement, comprising:
a classifier that is trained using tuples of words from appropriate advertisements and tuples of words from inappropriate advertisements;
a component that identifies tuples of words of the target advertisement; and
a component that indicates to approve the target advertisement based on applying the classifier to the identified tuples.

17. The computing device of claim 16 wherein the classifier is based on a support vector machine.

18. The computing device of claim 16 wherein the advertisements used to train the classifier were initially designated as being potentially inappropriate and then designated as appropriate or inappropriate.

19. The computing device of claim 16 further including:
a training data store including advertisements, each advertisement designated as either appropriate or inappropriate;
a component that identifies tuples of words of the advertisements of the training data; and
a component that, for unique tuples of words identified from an appropriate advertisement, generates an appropriate tuple score and, for unique tuples of words identified from an inappropriate advertisement, generates an inappropriate tuple score.

20. The computing device of claim 19 wherein the classifier generates an appropriate advertisement score that is a sum of the appropriate tuple scores and an inappropriate advertisement score that is a sum of the inappropriate tuple scores and classifies the target advertisement as appropriate when the appropriate advertisement score and the inappropriate advertisement score satisfy an approval criterion.
